(19) United States
(12) Patent Application Publication
(10) Pub. No.: US 2011/0105667 A1
(43) Pub. Date: May 5, 2011

(54) POLYOLEFIN COMPOSITION

(76) Inventors: Chris Brenner, Evansville, IN (US); Chris Pollock, Boonville, IN (US)

(21) Appl. No.: 12/708,966

(22) Filed: Feb. 19, 2010

Related U.S. Application Data
(60) Provisional application No. 61/256,596, filed on Oct. 30, 2009.

(51) Int. Cl. C08L 23/12; C08K 3/34; C08K 3/26; C08K 3/30

(52) U.S. Cl. 524/423; 525/240; 524/528; 524/451; 524/427; 524/449

(57) ABSTRACT

An inventive polyolefin material is provided that includes post-consumer recycled content. The material offers surprisingly superior melt flow characteristics and flame properties that improve handling and usefulness for formation of molded articles. The inventive material is optionally an alloy of polypropylene and high density polyethylene combined α-olefin copolymer and a filler.

### FIELD OF THE INVENTION

The present invention relates to polyolefin materials. The inventive materials demonstrate surprisingly improved processing and burning characteristics. Optionally, the inventive materials are formed from recycled post-consumer source matter. Inventive processes are also provided for the production of inventive polyolefin alloys from recycled source material. The invention is particularly suitable for applications including dunnage, packaging, and containers.

### BACKGROUND OF THE INVENTION

One of the many technical difficulties associated with using recycled post-consumer plastic waste materials is the incompatibility of different polymer materials found in plastic waste such as polypropylene, polyethylene, polystyrene, polyvinyl chloride, and others. These blends of incompatible or thermodynamically immiscible polymers generally exhibit poor mechanical properties and present numerous difficulties in processing.

The majority of municipal, mixed post-consumer plastic waste includes polyethylene terephthalate (PET) materials, such as soda bottles and unpigmented high density polyethylene (HDPE) materials, such as milk bottles, as well as other materials and types of plastic. Typical waste stream processing of soda and milk bottles includes separation of these materials by density to yield streams of recycled extruded HDPE and PET.

The remainder of the plastic waste stream includes containers of mixed resin types and pigments, and usually includes a predominance of polyolefins such as polyethylene (PE) and polypropylene (PP), as well as polystyrene (PS), polyvinyl chloride (PVC), and non-soda bottle PET. Separated material from the waste stream includes other resins, in addition to some PET and HDPE materials that are not previously sorted.

Bottle caps represent a large portion of unused plastic waste material due to the mixed nature of the plastic materials used in the bottle caps. The mixed plastics represent poor material for the production of subsequent products.

It has been considered economically unfeasible to reuse these remainder materials due to the low grade nature of the resulting extruded products. Due to the large proportion of recycled waste forming a mixed material of two or more polymers such as PP and HDPE, much of the waste is considered unusable for subsequent manufacturing or article production. Thus, there exists a need for materials produced from post-consumer waste that demonstrate improved handling and physical characteristics as well as economical methods for their production.

### SUMMARY OF THE INVENTION

An inventive polyolefin material is provided that includes a blend of polypropylene (PP) present from 10 to 70 percent by weight and high density polyethylene (HDPE) present at 10 to 70 percent by weight. The ratio of PP:HDPE is optionally 5:1 to 1:5. In some embodiments, the ratio of PP:HDPE is 1:1.

The HDPE optionally has a melt flow rate of 0.1 to 10 grams/10 minutes.

The PP optionally has a melt flow rate 10 to 30 grams/10 minutes.

The material also contains a filler. A filler is optionally talc, calcium carbonate, glass fiber, mica, clay, barium sulfate, wollastonite, or combinations thereof. In a some embodiments the filler is present from 0.1 to 25% by weight. Optionally, filler is talc. Talc optionally has a mean particle diameter size ranging from 1 to 20 micrometers.

An inventive composition optionally includes ethylene α-olefin copolymer at 0.1 to 5 percent by weight. The cc-olefin is optionally hexene, butene, octene, or a combination thereof.

The inventive material also optionally includes low density polyethylene optionally present at 0.1 to 10 percent by weight. The low density polyethylene optionally has a melt flow rate of 1 to 20 grams/10 minutes.

The inventive material also optionally includes linear low density polyethylene. The linear low density polyethylene optionally has a melt flow rate from 1 to 20 grams/10 minutes. A weight percentage of linear low density polyethylene is optionally 0.1 to 10 percent by weight. The linear low density polyethylene is optionally a copolymer with ethylene, hexene, or octene.

Optionally, at least a portion of the PP or HDPE is post-consumer recycled content. The post-consumer recycled content is optionally from about 5 to 25 weight percent. Optionally, the post-consumer recycled content is from about 5 to 100 weight percent. Optionally, the post-consumer recycled PP or HDPE content is 100 weight percent.

Also provided is a thermoplastic material with a polypropylene based thermoplastic having about 20 to 40 percent w/w elastomeric ethylene α-copolymer wherein the thermoplastic material is extruded with 10 to 25 percent by weight PP from post-consumer recycled material.

The thermoplastic optionally includes a filler that is talc, calcium carbonate, glass fiber, mica, clay, barium sulfate, wollastonite, or combinations thereof.

The inventive thermoplastic optionally includes an ethylene α-olefin copolymer present at 5 to 20 percent by weight. The α-olefin is optionally propene, butene, hexene, or octene.

### BRIEF DESCRIPTION OF THE DRAWINGS

FIG. 1 represents surprising heat release properties by an embodiment of the inventive material;

FIG. 2 represents effective heat of combustion EHC by an embodiment of the inventive material;

FIG. 3 represents total smoke release exhibited by an embodiment of the inventive material;

FIG. 4 represents total heat released by an embodiment of the inventive material;

FIG. 5 represents the relative viscosity as a function of shear rate of an embodiment of the inventive material.

### DETAILED DESCRIPTION OF THE PREFERRED EMBODIMENTS

The present invention provides a polyolefin material with surprisingly improved processing and burning characteristics. Also provided is a method of processing post-consumer waste products as well as virgin materials in the manufacture of the inventive polyolefin composition. The invention has utility as material suitable for use in articles such as dunnage, packaging, and containers.

The invention provides material that solves the long felt need for functional uses of recycled material, such as from bottle caps, that previously was unrecognized as suitable for subsequent reuse in high quality article manufacture. The skill in the art considers blended recycled material of polypropylene and high density polyethylene, as an example, to be unsuitable for manufacture of high quality polymeric articles. The present invention addresses this long felt need by providing a composition that can use polypropylene or high density polyethylene alone or in combination from 100 percent post-consumer recycled material. Illustratively, bottle caps are a source of high waste levels in landfills. Some embodiments of the inventive composition provide high quality, desirable polymer material made from normally discarded bottle cap materials. The unique flame and extrusion properties of the inventive material address present commercial demands while simultaneously decreasing the detrimental environmental consequences of continued bottle cap or other polymeric material waste.

An inventive composition illustratively includes a polyolefin alloy of polypropylene (PP) and high density polyethylene (HDPE). These materials are illustratively obtained from post-consumer waste products or other industrial sources known in the art.

Polypropylene operable in the present invention is optionally a homopolymer, impact copolymer, or random copolymer. Polypropylene is illustratively isotactic, atactic, or syndiotactic polypropylene. Optionally, polypropylene is isotactic polypropylene as this form has good processability during extrusion and molding or thermoforming. Syndiotactic polypropylene also has good impact characteristics that are in many cases superior to isotactic polypropylene. Syndiotactic polypropylene has a relatively low melting point, slow solidification rate and narrow molecular weight distribution.

Polypropylene is generally produced with different molecular chain structures under controlled conditions such as stereospecific conditions with the isotactic form produced in large quantities. Isotactic PP is typically produced utilizing either a Ziegler-Natta catalyst or metallocene catalyst system. Metallocenes useful in the preparation of isotactic PP are the chiral, stereorigid metallocenes. Metallocene catalyst systems used in preparing isotactic PP for use in the present invention include those disclosed and described in European Patent Application No. 87870132.5 (Publication No. 0 284 708 published Oct. 5, 1988), U.S. Pat. Nos. 4,794,096 and 4,975,403, and U.S. patent application Ser. No. 07/911,634, filed Jul. 10, 1992, all of which are herein incorporated by reference.

Ziegler-Natta catalysts, which are also well known in the art, useful in the preparation of isotactic PP are derived from a halide of a transition metal, such as titanium, chromium or vanadium with a metal hydride and/or metal alkyl, typically an organoaluminum compound as a co-catalyst. The catalyst is usually comprised of a titanium halide supported on a magnesium compound. Ziegler-Natta catalysts, such as titanium tetrachloride (TiCl₄) supported on an active magnesium dihalide, such as magnesium dichloride or magnesium dibromide, as disclosed, for example, in U.S. Pat. Nos. 4,298,718 and 4,544,717, both to Mayr et al., and which are herein incorporated by reference, are supported catalysts. Silica may also be used as a support. The supported catalyst may be employed in conjunction with a co-catalyst or electron donor such as an alkylaluminum compound, for example, triethylaluminum (TEAL), trimethyl aluminum (TMA) and triisobutyl aluminum (TIBAL).

While virgin PP is operable herein, an optional source for polypropylene is post-consumer recycled matter.

The isotactic PP used in the present invention may be a propylene homopolymer, which may be prepared from either Ziegler-Natta or metallocene catalyst useful in preparing isotactic polymers. The isotactic PP component employed optionally has a meso dyad content, as determined by ¹³C-NMR spectra, of at least 75%, and may be at least 95%. The isotactic PP also optionally includes some amount of syndiotactic PP as a polymer blend. Where such blends are employed, typically the amount of syndiotactic PP will be less than 50% by total weight of polymer, with from about 0.5% to about 25% being more typical. The polymer blends are optionally melt blended within an extruder, such as during extrusion of the polymer sheet. Alternatively, the polymer blends are reactor blended, such as described in U.S. Pat. No. 6,362,125, which is herein incorporated by reference.

An illustrative impact copolymer is described in U.S. Pat. No. 6,660,808, the contents of which are incorporated herein by reference.

The isotactic PP used in the present invention optionally includes isotactic propylene random copolymers that are illustratively prepared from either Ziegler-Natta or metallocene catalysts useful in the preparation of isotactic polymers. The isotactic propylene component of the random copolymers employed typically have a meso dyad content, as determined by ¹³C-NMR spectra, of at least 75%, and may be at least 95%. Those copolymers typically used in the present invention are those propylene copolymers of the olefin monomers having from 2 to 10 carbon atoms, with ethylene being the most common co-monomer employed.

Polypropylene is optionally a thermoplastic blend of 60 to 80 percent polypropylene with an ethylene α-olefin copolymer that is elastomeric. Optional α-olefins illustratively include propene, butene, hexane, and octene. The copolymer is optionally present in the thermoplastic blend at a weight range of 20-40 percent.

Polypropylene optionally has a melt flow rate from 5 to 100 grams/10 minutes when measured at 230° C./2.16 kg. Optionally the PP melt flow rate is 5-50 grams/10 minutes. Optionally the PP melt flow rate is 7-40 grams/10 minutes. Optionally, the PP melt flow rate is 10-30 grams/10 minutes.

The inventive material optionally includes an alloy of polypropylene and high density polyethylene. In some embodiments the alloy contains 10-70 percent polypropylene. Optionally, polypropylene percentages are 30-50 percent. Optionally, polypropylene is present in a range of 35-45 percent.

HDPE operable for use in the inventive material is optionally obtained by homopolymerizing ethylene alone or copolymerizing ethylene and α-olefin having a number of carbon atoms of 3 to 12 (optionally 3 to 8) in the presence of a Philips catalyst or Ziegler catalyst, and generally are produced under a pressure of atmospheric pressure to about 100 kg/cm² (moderate to low pressure polymerization). Examples of the α-olefin optionally include propylene, butene-1, hexene-1, 4-methylpentene-1 and octene-1. The copolymerization ratio is optionally 6.5 wt % at most, and optionally not more than 6.0 wt %. The number of branched short chains per 1,000 carbon atoms of the main chain in the HDPE is optionally less than 20.

The density of HDPE is optionally least 0.93 g/cm³, optionally at least 0.94 g/cm³ and optionally at least 0.94 g/cm³. Optionally, HDPE has a specific gravity in the range of 0.94 g/cm³ to 0.96 g/cm³. It is appreciated that HDPE specific gravity is optionally in excess of 0.96 g/cm³.

Optionally, the melt flow rate of HDPE is at least 0.01 g/10 minutes, optionally at least 0.015 g/10 minutes, and optionally at least 0.02 g/10 minutes. Optionally, the melt flow rate of HDPE is 0.05-20 grams/10 minutes when measured at 190° C./2.16 kg.

Components of the polyolefin composition include but are not limited to materials provided as virgin pellets, virgin powder, virgin flake, recycled, reprocessed, regrind, off specification and wide specification grades of PP and HDPE. This invention discloses the criteria for blending the PP and HDPE components regardless of the grade utilized. In this way the manufacturer has the capability of selecting the most cost effective grade of HDPE.

High density polyethylene is provided in the inventive alloy material at 10-70 percent by weight. Optionally, HDPE is present at 30-50 percent by weight. Optionally, high density polyethylene is 35-45 percent by weight. The specific ratios of polypropylene to high density polyethylene are optionally 5:1 to 1:5. Optionally, the ratios of polypropylene to high density polyethylene are 2:1 to 1:2. Optionally, the ratios of polypropylene to high density polyethylene 1.5:1.0 to 1.0:1.5. Optionally, polypropylene and high density polyethylene are provided at equal weight percentages.

An inventive composition optionally contains ethylene-α-olefin copolymer. The α-olefin is illustratively a hexene, butene, or octene. Optionally, an α-olefin is octene. In the inventive composition the ethylene-α-olefin copolymer is optionally present at 0-5 percent by weight. Optionally, the ethylene-α-olefin copolymer is present at 1-3 percent by weight. Optionally, the ethylene-α-olefin copolymer is present at 2 percent by weight. An α-olefin operable in the present invention is optionally branched or linear. It is to be appreciated that other α-olefins are similarly operable herein.

An α-olefin copolymer is optionally reacted with an unsaturated carboxylic acid or unsaturated carboxylic acid anhydride reagent. The copolymer/reagent product is optionally included in the inventive material when blends of thermodynamically immiscible polymers are present, but is otherwise operable herein. A copolymer/reagent product is optionally present at 0.5 to 10 percent by weight. Optionally, a copolymer/reagent product is present at 0.5 to 2 percent by weight.

Unsaturated carboxylic acid or unsaturated carboxylic acid anhydride includes derivatives of such acids and mixtures thereof. Examples of the acids and anhydrides are optionally mono-, di- or polycarboxylic acids. Optionally, acids and anhydrides are: acrylic acid; methacrylic acid; maleic acid; fumaric acid; itaconic acid; crotonic acid; itaconic anhydride; maleic anhydride; substituted maleic anhydride, e.g. dimethyl maleic anhydride; citraconic anhydride; nadic anhydride; nadic methyl anhydride; and tetrahydrophthalic anhydride. Illustrative examples of the derivatives of the unsaturated acids are: salts; amides; imides; and esters. Illustratively derivatives of the unsaturated acids are mono- and disodium maleate, acrylamide, maleimide, glycidyl methacrylate and dimethyl fumarate. Illustrative techniques for reacting of such monomers with the α-olefin are described in U.S. Pat. No. 4,612,155 and U.S. Pat. No. 5,618,881 the contents of which are incorporated herein by reference.

An inventive composition optionally includes a filler. A filler is illustratively talc, calcium carbonate, glass fiber, mica, clay, barium sulfate, or wollastonite. Optionally, a filler is talc, mica, or clay. Optionally, the filler is talc. In this embodiment talc is optionally 1-20 micrometers median particle size. Optionally, talc is 7-13 micrometers median particle size. A filler is illustratively present from 0-20 weight percent. Optionally, a filler is present at 5-15 weight percent. It is to be appreciated that other fillers known in the art are similarly operable. In some embodiments a filler is absent.

The inventive composition optionally includes low density polyethylene. Low density polyethylenes for use in the present invention optionally have a melt flow rate of 1-20 grams/10 minutes when measured at 190° C./2.16 kilograms. When provided, low density polyethylene is optionally present at 1-10 percent by weight. Optionally, low density polyethylene is present at 3-7 weight percent. Optionally, low density polyethylene is present at 5 percent by weight.

In another embodiment the present invention illustratively includes linear low density polyethylene. Illustrative linear low density polyethylenes (LLDPE) are produced by copolymerization with ethylene and higher alpha-olefins illustratively including butene, hexene, or octene.

The density of LLDPE is optionally from 0.910/cm³ to less than 0.935 g/cm³, optionally at least 0.912 g/cm³, and optionally from 0.915 g/cm³ to less than 0.935 g/cm³. The number of branched short chains per 1,000 carbon atoms of the main chain is optionally from 5 to 30, with the range of from 5 to 25 being particularly suitable.

When present, an LLDPE is optionally at 0.01-10 percent by weight. Optionally, LLDPE is present at 3-7 percent by weight. Optionally, LLDPE is present at 5 percent by weight.

LLDPE optionally has a melt flow of 1 to 20 grams/10 minutes when measured at 190° C./2.16 kilograms.

The inventive compositions also illustratively include an additive. Additives operable herein are illustratively antioxidants, clarifiers, nucleating agents, colorants, anti-UV agents, antistatic agents, antifog agents, slip agents, antiblock agents, neutralizers, pigments, processing aids, flame retardants, compatibilizers, and other additives known in the art. These additives are optionally added during production of the base polymer or during the sheet extrusion process. Specific examples of additives operable in the present invention illustratively include those listed Table 1. Additional specific examples are illustrated in Plastics Additives Handbook: Stabilizers, Processing Aids, Plasticizers, Fillers, Reinforcements, Colorants for Thermoplastics, 4th Edition. Edited by R. Gächter and H. Müller. Associate Editor, P. P. Klemchuk. 1993, Hanser/Gardner Publications. Cincinnati, Ohio, the contents of which are incorporated herein by reference with particularity for the additives taught therein.

TABLE 1

Flame retardants
MCA N series flame retardant PA66, PA6, PP
MP N P series flame retardant PP, PU, PC, PET, PBT
CEEPA PET
TPP, RDP, BDP
MC-15, 25, 50
Light Stabilizers
Absorbent uv-p
Uv absorbent uv-0
Uv absorbent uv-9
Uv absorbent uv-1
Uv absorbent uv-2
Uv absorbent uv-24
Uv absorbent uv234
Uv absorbent uv-320
Uv absorbent uv326
Uv absorbent uv-327
Uv absorbent uv-328
Uv absorbent uv-329
Uv absorbent uv-531
Light stability agent hs-292 (hals 292)
Light stability agent hs-770 (hals-770)
Light stability agent hs-944 (hals-944)
Light stability agent hals gw-106
Quality: Same as tinuvin-622)
Light stability agnebt hals gw-108
Quality: Same as tinvin-292, tinvin-765, sanol ls-765
Light stability agent hs-201
Light stability agent bw-10 ld (622 ld)
Antioxidants
Antioxidant 1076 antioxidants Irganox 1076
Antioxidant 1135 antioxidants Irganox 1135
Antioxidant 2246 antioxidants Irganox 2246
Antioxidant 1098 antioxidants Irganox 1098
Antioxidant 1010 antioxidants Irganox 1010
Antioxidant 1035 antioxidants Irganox 1035
Antioxidant 1081 antioxidants Irganox 1081
Antioxidant 3125 antioxidants Irganox 3125
Antioxidant 1425 antioxidants Irganox 1425
Antioxidant 1010
Antioxidant 1076
Antioxidant BHT
Antioxidant 2246
Antioxidant 215
Antioxidant 225
Antioxidant 168
Nucleating agents (clarifying agent)
Type Use Equivalent
NZ-122 PP Milliken 3988
NZ-235 PP
Acrylic Impact Modifier (AIM)
MBS

In some embodiments the inventive material is a polyolefin alloy including polypropylene present at 35 to 45 percent by weight, high density polyethylene present at 35 to 45 percent by weight, talc present at 5 to 15 percent by weight, and ethylene octene copolymer present at 1 to 5 percent by weight. Optionally included are low density polyethylene at 2 to 7 percent by weight and linear low density polyethylene present at 2 to 7 percent by weight. The inventive composition optionally includes one or more additives.

The inventive material optionally contains post-consumer recycled content. Post-consumer recycled content illustratively includes bottle caps, packaging, cups, film, and bottles. In some embodiments the amount of post-consumer recycled content is in excess of 10%. Optionally, the amount of post-consumer recycled material exceeds 15%, 20%, 25%, 30%, 35%, 40%, 45%, 50%, 55%, 60%, 65%, 70%, 75%, 80%, 85%, 90%, 95% and 99%. Optionally, the PP and HDPE are 100% post-consumer recycled content. Optionally, the post-consumer recycled content is a mix of HDPE and PP. In some embodiments the post-consumer recycled content is 60%/40% w/w HDPE/PP.

An inventive process optionally includes extrusion blending of materials to form an alloy. All raw materials are combined in a paddle or ribbon blender for 30 minutes to one hour at ambient temperature. The blend is then fed into a single or twin screw extruder. Temperatures of extrusion are optionally at 200° C.-260° C. The material is extruded at 50-100% of the maximum available screw RPM. The material is extruded into strands illustratively 2 mm in diameter, cooled in a water bath optionally at ambient temperature or below, excess water is removed via air knife, strands are then chopped into pellets and classified. The inventive extrusion process for post-consumer recycled material is similar to that of virgin material, however, there are washing and grinding operations used in processing post-consumer items into useful form such as grinding, densifying, and aspirating. The recycled material is optionally processed illustratively by magnetic or screening removal of contaminants such as metals or drying. Recycled material is optionally ground prior to use in formation of the inventive material.

Surprisingly, the inventive material demonstrates improved injection molding characteristics as opposed to standard prime high density polyethylene as known in the art. Unexpectedly, and in addition to the improved injection molding characteristics, the inventive material demonstrates improved flame properties versus prime high density polyethylene as measured by cone calorimeter.

The following examples illustrate a preparation of an optional inventive polyolefin material.

### Example 1

An inventive polyolefin material of Formula A is prepared from the following components and as shown in Table 2:
a. An isotactic homopolymer of polypropylene and ethylene containing 10% of ethylene comonomer with a melt flow rate of 20 grams/10 minutes at 230° C./2.16 kilograms present at 39% by weight.
b. A high density polyethylene with a specific gravity of 0.95 and a melt flow rate of 5 grams/10 minutes at 190° C./2.16 kilograms present at 39% by weight.
c. An ethylene-α-olefin copolymer present at 2% by weight where the α-olefin is octene.
d. Talc with a 10 micrometer median particle size present at 10% by weight.
e. Low density polyethylene having a melt flow rate of 10 grams/10 minutes when measured at 190° C./2.16 kg present at 5% by weight.
f. A linear low density polyethylene present at 5% by weight. The linear low density polyethylene has a melt flow of 10 grams/10 minutes when measured at 190° C./2.16 kg. The linear low density polyethylene is a copolymer of octene.

TABLE 2

| Formula A | Percent w/w |
|---|---|
| Polypropylene | 39 |
| High Density Polyethylene | 39 |
| Talc - 9103 | 10 |
| Octene copolymer | 2 |
| Low Density Polyethylene | 5 |
| Linear Low Density | 5 |
| Polyethylene | |

The alloy is prepared in a Werner and Pfleiderer single screw extruder with a diameter ranging from 1 inch to 6.5 inches. Before and after the preparation the hopper is flushed with nitrogen gas to provide an approximately inert atmosphere. The screw speed is 200 rpm, and the rate of extrusion is 80 kg/hour. Samples are compounded at 230° C. The components are added at the amounts specified above in percent weight of the total blend.

Blends of alloy and HDPE are compounded as described for the alloy above using 55% by weight of the above alloy and 45% by weight HDPE with a melt flow rate of 10 grams/10 minutes when measured at 190° C./2.16 kg and a specific gravity of 0.95.

Extruded sheets of the Formula A alloy and blend with a thickness of 3.3 millimeters are subjected to flame property testing using a cone calorimeter at a heat flux of 50 kW/m² and a nominal duct flow rate of 24 L/s. Each sheet has an exposed surface area of 100 cm². Control samples represent replicates of 5MF HDPE, prime.

The following properties of the prepared materials are measured:
Time to ignition (TTI): (s)
Time to end of flaming period: (s)
Peak values and times to peak values: (s)
Heat release rate (HRR): (kW/m²)
Effective heat of combustion (EHC): (MJ/kg)
Specific extinction area (SEA): (m²/kg)
Rate of smoke release (RSR): (1/s)

The parameters of the test samples and test results are presented in Table 3.

TABLE 3
Flame properties of inventive alloys and blends as tested by cone
calorimetry.
ASTM E1354 Tests at 50 kW/m² without retainer frame or wire grid

| | | | | Avg | 3 min | Initial | Mass | EHC | EHC |
|---|---|---|---|---|---|---|---|---|---|
| Product | | TTI | Pk HRR | HRR | HRR | Mass | Loss | Avg | Pk |
| Reference | Test # | (s) | (kW/m²) | (kW/m²) | (kW/m²) | (g) | (g) | (MJ/kg) | (MJ/kg) |
| Control | 09060001 | 65 | 2354.7 | 365.4 | 0.0 | 29.80 | 29.6 | 11.7 | 77.7 |
| Control | 09060004 | 67 | 2521.6 | 371.0 | 0.0 | 29.70 | 29.7 | 10.8 | 77.2 |
| Control | 09060010 | 67 | 2086.6 | 316.9 | 340.1 | 29.80 | 27.6 | 10.1 | 74.5 |
| Av | Average | 66.3 | 2321.0 | 351.1 | 113.4 | 29.77 | 28.9 | 10.9 | 76.5 |
| Control | | | | | | | | | |
| Alloy | 09060002 | 45 | 978.1 | 331.8 | 0.0 | 31.30 | 28.0 | 18.4 | 77.7 |
| Alloy | 09060005 | 43 | 973.9 | 340.8 | 0.0 | 31.30 | 27.7 | 18.2 | 70.4 |
| Alloy | 09060008 | 43 | 978.5 | 319.9 | 0.0 | 31.30 | 27.6 | 17.9 | 71.4 |
| Av Alloy | Average | 43.7 | 976.9 | 330.8 | 0.0 | 31.30 | 27.8 | 18.1 | 73.1 |
| Blend | 09060003 | 60 | 1078.0 | 329.1 | 0.0 | 30.30 | 28.8 | 17.0 | 78.4 |
| Blend | 09060006 | 56 | 1133.0 | 343.5 | 0.0 | 30.30 | 28.5 | 16.0 | 79.6 |
| Blend | 09060009 | 54 | 1106.2 | 341.3 | 0.0 | 30.50 | 28.5 | 16.7 | 69.7 |
| Av Blend | Average | 56.7 | 1105.7 | 337.9 | 0.0 | 30.37 | 28.6 | 16.6 | 75.9 |

| | | | | Pk | Avg | Avg | | |
|---|---|---|---|---|---|---|---|---|
| | | THR | TSR | RSR | RSR | SEA | FPI | MAHRE |
| Product Reference | Test # | (MJ/m²) | (—) | (1/s) | (1/s) | (m²/kg) | (s m²/kW) | (kW/m²) |
| Control | 09060001 | 109.6 | 1589.0 | 23.5 | 5.3 | 355.7 | 0.028 | 576.1 |
| Control | 09060004 | 110.2 | 1614.3 | 24.0 | 5.4 | 349.3 | 0.027 | 579.8 |
| Control | 09060010 | 102.4 | 1726.9 | 24.1 | 5.3 | 384.9 | 0.032 | 548.0 |
| Av | Average | 107.4 | 1643.4 | 23.9 | 5.3 | 363.3 | 0.029 | 568.0 |
| Control | | | | | | | | |
| Alloy | 09060002 | 102.9 | 1940.3 | 18.7 | 6.2 | 386.9 | 0.046 | 526.4 |
| Alloy | 09060005 | 103.9 | 1956.6 | 18.1 | 6.4 | 396.1 | 0.044 | 525.7 |
| Alloy | 09060008 | 103.7 | 2047.6 | 17.8 | 6.3 | 421.6 | 0.044 | 511.0 |
| Av Alloy | Average | 103.5 | 1981.5 | 18.2 | 6.3 | 401.6 | 0.045 | 521.1 |
| Blend | 09060003 | 105.6 | 1918.9 | 18.9 | 5.9 | 381.1 | 0.056 | 507.3 |
| Blend | 09060006 | 107.2 | 1938.6 | 21.1 | 6.2 | 422.4 | 0.049 | 532.5 |
| Blend | 09060009 | 105.4 | 2020.0 | 21.0 | 6.5 | 370.8 | 0.049 | 531.8 |
| Av Blend | Average | 106.1 | 1959.2 | 20.3 | 6.2 | 391.4 | 0.051 | 523.9 |

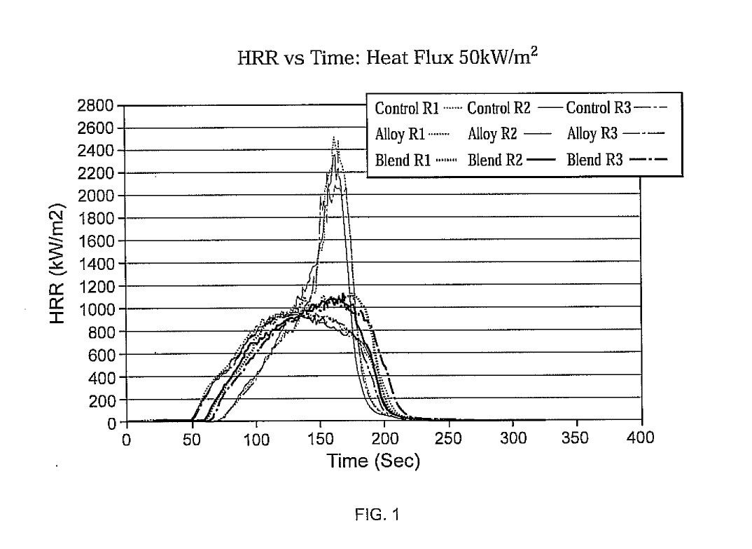

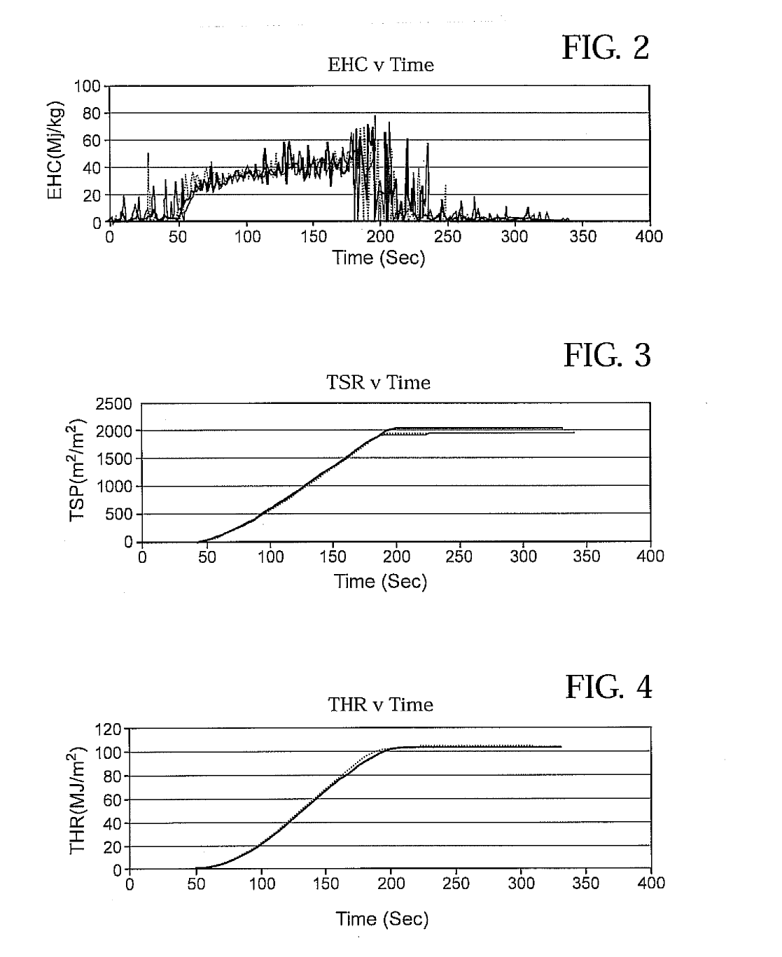

The inventive Formula A alloy and blends with HDPE both show unexpectedly lower peak heat release rates (HRR) compared to control. (FIG. 1) Additionally, the presence of the inventive alloy demonstrates no measurable HRR at 3 minutes. FIG. 2 demonstrates the effective heat of combustion EHC of the inventive alloy. The average EHC of the inventive alloy and blends thereof are unexpectedly higher than control samples. (Table 3)

The total smoke release is illustrated in FIG. 3. The presence of the inventive Formula A alloy produces a higher average smoke release rate and corresponding higher total smoke release. (Table 3)

Total heat released is illustrated in FIG. 4. While the peak heat release rates of a sample of an article containing the inventive Formula A alloy are lower than control, the average heat release rates are less distinguishable. (Table 3)

Overall, unexpected improvements are observed in both injection molding characteristics and flame properties of the material of Formula A alone or in a blend as opposed to the prime high density polyethylene comparator (control).

A blend of the inventive alloy with HDPE using 10% of 5 MF and 29% of 0.8 MF is also produced. In addition, the following blends are injection molded into articles:
Formula A Alloy+4% Decabromodiphenyl oxide (DBDPO)+2% Antimony Trioxide (Sb₂O₃)
Control+4% DBDPO+2% Sb₂O₃
1.2:1 Ratio of Alloy:Control+4% DBDPO+2% Sb₂O₃

### Example 2

The molding characteristics of the alloy of Formula A are measured and compared to control of 5MF HDPE, prime as control material. Material characteristics are shown in Table 3.

TABLE 4

| | | | | |
|---|---|---|---|---|
| Injection | | | | |
| Speed | Peak | Shear | Plastic | |
| (cm³/sec) | Pressure | Rate | Pressure | Viscosity |

FORMULA A

| | | | | |
|---|---|---|---|---|
| 9 | 318 | 0.110 | 3180 | 28909 |
| 18 | 370 | 0.219 | 3700 | 16895 |
| 27 | 435 | 0.329 | 4350 | 13222 |
| 36 | 496 | 0.439 | 4960 | 11298 |
| 45 | 568 | 0.548 | 5680 | 10365 |
| 54 | 646 | 0.658 | 6460 | 9818 |
| 63 | 745 | 0.768 | 7450 | 9701 |
| 72 | 804 | 0.877 | 8040 | 9168 |
| 81 | 893 | 0.987 | 8930 | 9048 |
| 90 | 914 | 1.02 | 9140 | 8961 |

CONTROL

| | | | | |
|---|---|---|---|---|
| 9 | 426 | 0.110 | 4260 | 38841 |
| 18 | 566 | 0.219 | 5660 | 25803 |
| 27 | 677 | 0.329 | 6770 | 20575 |
| 36 | 772 | 0.439 | 7720 | 17597 |
| 45 | 875 | 0.548 | 8750 | 15956 |
| 54 | 976 | 0.658 | 9760 | 14831 |
| 63 | 1085 | 0.768 | 10850 | 14132 |
| 72 | 1190 | 0.877 | 11900 | 13653 |
| 81 | 1225 | 0.987 | 12250 | 12410 |
| 90 | 1213 | 1.01 | 12130 | 11975 |

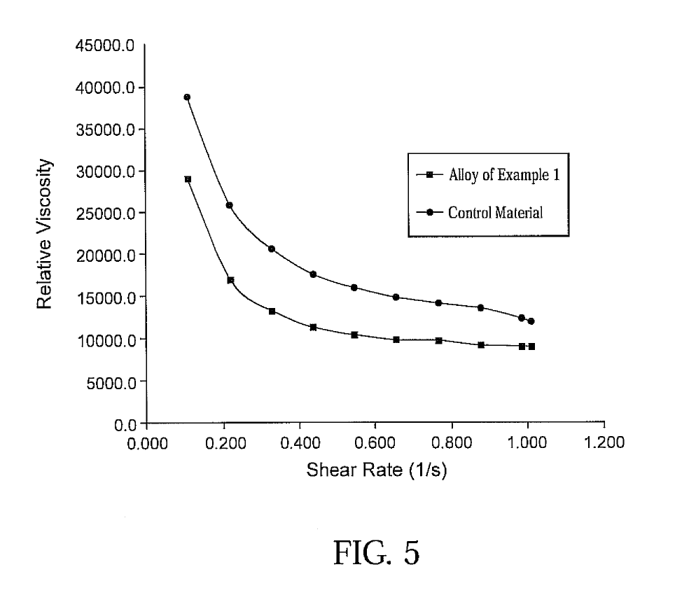

The relative viscosity of the alloy of Formula A is lower at equivalent shear rates compared to control. (FIG. 5)

### Example 3

An inventive mixture including the following of Formula B is prepared.

TABLE 5

| Formula B | Percent w/w |
|---|---|
| Polypropylene | 55 |
| PCR HDPE/PP Blend | 25 |
| Talc - 9410 | 20 |

The Formula B material includes post consumer recycled material (PCR). The PCR is a blend of HDPE and PP at a ratio of 60% w/w HDPE to 40% w/w PP. Formula B is tested for flex modulus as per ASTM D790 and compared to identical material with virgin HDPE or with no HDPE. The material of Formula B shows no loss in flex modulus relative to control. Formula B demonstrates a flex modulus of 240,000 Pa and a Notched Izod of 0.6 ft-lb/in.

### Example 4

An inventive mixture including the following of Formula C is prepared as in Table 5.

TABLE 6

| Formula C | Percent w/w |
|---|---|
| Polypropylene | 55 |
| PCR HDPE/PP Blend | 25 |
| Glass fiber | 20 |

The Formula C material is tested for tensile strength and compared to identical material with virgin HDPE or with no HDPE. The PCR is a mixture of HDPE and PP at a ratio of 60% w/w HDPE to 40% w/w PP. The material of Formula B shows no loss in tensile strength. The Formula C material shows a Notched Izod of 1.2 ft-lb/in and a Tensile Strength of 7,900 psi.

### Example 5

A thermoplastic (TPO) material is formulated as in Table 6. The TPO is a blend of polypropylene homopolymer with an elastomeric ethylene α-olefin copolymer of octene at 30 percent.

TABLE 7

| Raw material | 1 | 2 | 3 | 4 | 5 | 6 | 7 | 8 |
|---|---|---|---|---|---|---|---|---|
| TPO RG | 99.3 | 89.3 | 74.3 | 67.3 | 79.3 | 69.3 | 59.3 | 52.3 |
| SIGNODE PP CAP RG | 0 | 0 | 25 | 22 | 0 | 0 | 20 | 17 |
| Off-Grade Engage | 0 | 10 | 0 | 10 | 0 | 10 | 0 | 10 |
| Talc 9103 | 0 | 0 | 0 | 0 | 20 | 20 | 20 | 20 |
| B-110 | 0.2 | 0.2 | 0.2 | 0.2 | 0.2 | 0.2 | 0.2 | 0.2 |
| EBS Wax | 0.25 | 0.25 | 0.25 | 0.25 | 0.25 | 0.25 | 0.25 | 0.25 |
| Calcium Stearate | 0.25 | 0.25 | 0.25 | 0.25 | 0.25 | 0.25 | 0.25 | 0.25 |
| TOTAL | 100 | 100 | 100 | 100 | 100 | 100 | 100 | 100 |

The thermoplastic material is tested for a variety of physical characteristics by standard techniques known in the art. The results are presented in Table 7.

TABLE 8

| | | Test Formulation | | | | | | | |
|---|---|---|---|---|---|---|---|---|---|
| Physical Property | Units | 1 | 2 | 3 | 4 | 5 | 6 | 7 | 8 |
| Melt Flow (230° C.@ 2.16 kg) | g/10 min | 20.7 | 16.5 | 16.2 | 16.8 | 17.5 | 12.7 | 13.1 | 11.7 |
| Ash Content | % | 9.8 | 8 | 9.1 | 8.2 | 26.2 | 26.4 | 28 | 28.4 |
| Izod, Notched | ft-lb/in | 10.8 NB | 11.3 NB | 9.9 NB | 11.4 NB | 10.3 NB | 11.4 NB | 6.5 | 9.4 NB |
| Gardner Impact | in-lb | 160 | 160 | 160 | 160 | 160 | 160 | 140 | 160 |
| Tensile Strength | psi | 2490 | 2010 | 2380 | 2150 | 2450 | 2080 | 2490 | 2300 |
| Flexural Strength | psi | 118.2 | 82 | 98.5 | 82.4 | 148.8 | 132.5 | 174 | 125.7 |
| Flexural Modulus, Tangent | psi | 3060 | 2240 | 2710 | 2360 | 3340 | 2680 | 3520 | 2920 |

The use of 25 percent post consumer recycled material demonstrates no loss of impact strength.

Patent documents and publications mentioned in the specification are indicative of the levels of those skilled in the art to which the invention pertains. These documents and publications are incorporated herein by reference to the same extent as if each individual document or publication was specifically and individually incorporated herein by reference. Furthermore, each document or publication mentioned in each incorporated reference are similarly hereby incorporated by reference as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A polyolefin material comprising:
polypropylene at 10 to 70 percent by weight wherein said polypropylene comprises post consumer recycled polypropylene;
high density polyethylene at 10 to 70 percent by weight wherein said high density polyethylene comprises post consumer recycled high density polyethylene,
wherein the ratio of said polypropylene to said high density polyethylene is from 5:1 to 1:5; and
ethylene α-olefin copolymer at 0.1 to 5 percent by weight.

2. The material of claim 1 further comprising a filler.

3. The material of claim 2 wherein said filler is selected from the group comprising talc, calcium carbonate, glass fiber, mica, clay, barium sulfate, wollastonite, or combinations thereof.

4. The material of claim 3 wherein said filler is talc with a mean particle diameter size ranging from 1 to 20 micrometers.

5. The material of claim 1 further comprising low density polyethylene having a melt flow rate of 1 to 20 grams/10 minutes.

6. The material of claim 5 wherein said low density polyethylene is present from 0.1 to 10 percent by weight.

7. The material of claim 1 further comprising linear low density polyethylene having a melt flow rate from 1 to 20 grams/10 minutes.

8. The material of claim 7 wherein said linear low density polyethylene is a copolymer with ethylene, hexene, or octene.

9. The material of claim 1 wherein said polypropylene or said high density polyethylene is at least 5 percent post-consumer recycled material.

10. The material of claim 1 wherein said α-olefin copolymer is an ethylene octene copolymer.

11. The material of claim 1 wherein said high density polyethylene is present at an equal or greater weight percent than said polypropylene.

12. A polyolefin material comprising:
polypropylene at 10 to 70 percent by weight;
high density polyethylene at 10 to 70 percent by weight, wherein the ratio of said polypropylene to said high density polyethylene is from 5:1 to 1:5; and ethylene α-olefin copolymer.

13. The material of claim 12 wherein said ethylene α-olefin copolymer is present at about 0.1 to about 5 percent by weight.

14. The material of claim 12 wherein the ratio of said polypropylene to high density polyethylene is from about 1:1 to about 1:2 by weight.

15. The material of claim 12 further comprising a filler selected from the group comprising: talc, calcium carbonate, glass fiber, mica, clay, barium sulfate, wollastonite, or combinations thereof.

16. The material of claim 12 further comprising low density polyethylene having a melt flow rate of 1 to 20 grams/10 minutes present from about 0.1 to about 10 percent by weight.

17. The material of claim 12 further comprising linear low density polyethylene having a melt flow rate from 1 to 20 grams/10 minutes.

18. The material of claim 17 wherein said linear low density polyethylene is a copolymer with ethylene, hexene, or octene.

19. The material of claim 12 wherein said polypropylene or high density polyethylene is at least part post-consumer recycled content.

20. The material of claim 19 wherein said post-consumer recycled material is derived from bottle caps.

21. A polyolefin alloy comprising:
polypropylene at 30 to 65 percent by weight having a melt flow rate of 10 to 30 grams/10 minutes, said polypropylene greater than 90 percent post-consumer recycled material;
high density polyethylene at 10 to 50 percent by weight having a melt flow rate of 0.1 to 10 grams/10 minutes, said high density polyethylene at least 90 percent post-consumer recycled material,
wherein the ratio of said polypropylene to said high density polyethylene is 1:2 to 2:1; and
ethylene α-olefin copolymer at 0.1 to 5 percent by weight wherein said α-olefin is hexene, butene, octene, or a combination thereof.

22. The alloy of claim 21 further comprising talc at 5 to 25 percent by weight.

23. The alloy of claim 21 further comprising low density polyethylene having a melt flow rate of 1 to 20 grams/10 minutes present at 0.1 to 10 percent by weight.

24. The alloy of claim 21 further comprising linear low density polyethylene having melt flow rate of 1 to 20 grams/10 minutes present at 0.1 to 10 percent by weight.
